(19) United States
(12) Patent Application Publication
(10) Pub. No.: US 2006/0177259 A1
(43) Pub. Date: Aug. 10, 2006

(54) Beam-to-beam connection structure for a storage rack

(75) Inventor: Fung Chuan Yang, Janhua Shien (TW)

Correspondence Address: CHARLES E. BAXLEY, ESQ., 90 JOHN STREET, THIRD FLOOR, NEW YORK, NY, 10038, US

(73) Assignee: Artek Furniture Co., Ltd.

(21) Appl. No.: 11/051,367

(22) Filed: Feb. 5, 2005

(51) Int. Cl. F16B 1/00

(52) U.S. Cl. 403/49

(57) ABSTRACT

a beam-to-beam connection structure for a storage rack comprises: at least two beams, each of which is provided with axial guide rails, at either side surface of the axial guide rails is defined a flange, in the respectively beams are defined connecting grooves and locking grooves; a connecting member is provided with through holes and fixing holes correspondingly to the axial guide rails and the connecting grooves of the beams, so that screws are screwed through the fixing holes into the connecting grooves of the beam, the connecting member is formed with connecting portions employed to insert in the locking grooves of the beams.

### BACKGROUND OF THE INVENTION

1. Field of the Invention

The present invention relates to a storage rack, and more particularly to a beam-to-beam connection structure for a storage rack.

2. Description of the Prior Arts

A rack is usually used to store, collect and display different articles, however, the conventional storage rack is always large in size and difficult to be transported.

To overcome this defect, various types of DIY storage rack have been made, however, these DIY storage racks are complicated in structure and difficult to be assembled.

The present invention has arisen to mitigate and/or obviate the afore-described disadvantages.

### SUMMARY OF THE INVENTION

The primary objective of the present invention is to provide a beam-to-beam connection structure for a storage rack, which enables the beams of a storage rack to be connected quickly via a slide member.

A beam-to-beam connection structure for a storage rack provided in accordance with the present invention comprises:

at least two beams, each of which being provided with axial guide rails, at either side surface of the respective axial guide rails is defined a flange, in the respectively beam being defined connecting grooves and locking grooves;

a connecting member provided with through holes and fixing holes correspondingly to the axial guide rails and the connecting grooves of the beams, respectively, screws being screwed through the fixing holes into the connecting grooves of the beam, the connecting member being formed with connecting portions employed to insert in the locking grooves of the beams.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a beam-to-beam connection structure for a storage rack in accordance with a preferred embodiment of the present invention;

FIG. 2 is a lateral cross sectional view of the beam-to-beam connection structure for a storage rack in accordance with the preferred embodiment of the present invention;

FIG. 3 is a longitudinal cross sectional view of the beam-to-beam connection structure for a storage rack in accordance with the preferred embodiment of the present invention;

FIG. 4 is a perspective view of the beam-to-beam connection structure for a storage rack in accordance with the preferred embodiment of the present invention;

FIG. 5 is an operational view of the beam-to-beam connection structure for a storage rack in accordance with the preferred embodiment of the present invention;

FIG. 6 is another operational view of the beam-to-beam connection structure for a storage rack in accordance with the preferred embodiment of the present invention.

### DETAILED DESCRIPTION OF THE PREFERRED EMBODIMENT

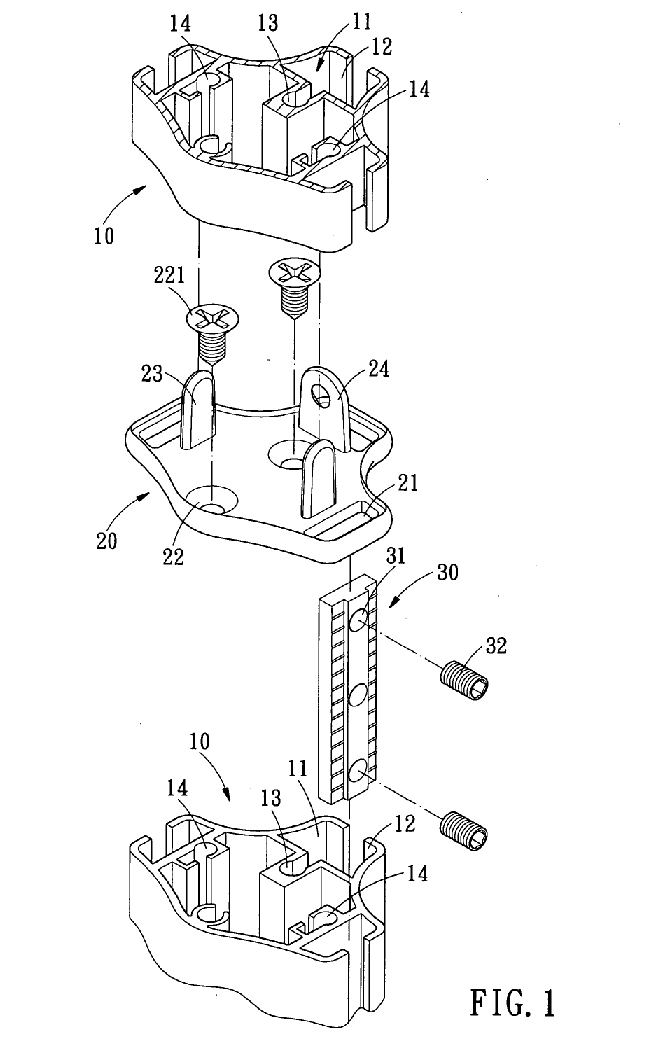

Referring to FIG. 1, a beam-to-beam connection structure for a storage rack in accordance with a preferred embodiment of the present invention is shown and comprises: two beams 10, a connecting member 20 and slide member 30.

The beams 10 are a unitary structure made by extrusion, each of which is provided with three axial guide rails 11 located on the three sides thereof. At either side surface of the respective axial guide rails 11 is defined a flange 12. In the beam 10 is defined two opposite connecting grooves 13 and two locking grooves 14.

The connecting member 20 is provided with three through holes 21 correspondingly to the three axial guide rails 11 of the respective beams 10, and is provided with two conical fixing holes 22 correspondingly to the two connecting grooves 13 of the beams 10, so that the connecting member 20 can be fixed to one of the beams 10 by screwing two screws 221 through the conical fixing holes 22 into the two connecting grooves 13 of the beam 10 to be connected. The connecting member 20 is further formed with two connecting portions 23 which are to be inserted in the locking grooves 14 of another beam 10. In addition, a projection 24 is formed on the connecting member 20 and used to insert in the axial guide rail 11 adjacent to the connecting groove 13 of the another beam 10.

The slide member 30 is “ [symbol] ”-shaped in cross section and provided with three threaded holes 31 on the ridge thereof for meshing with socket head screws 32, so that when the end of the socket head screws 32 is screwed to the surface of the axial guide rail 11, both edges of the slide member 30 will be caused to press against the flanges 12 of the beam 10.

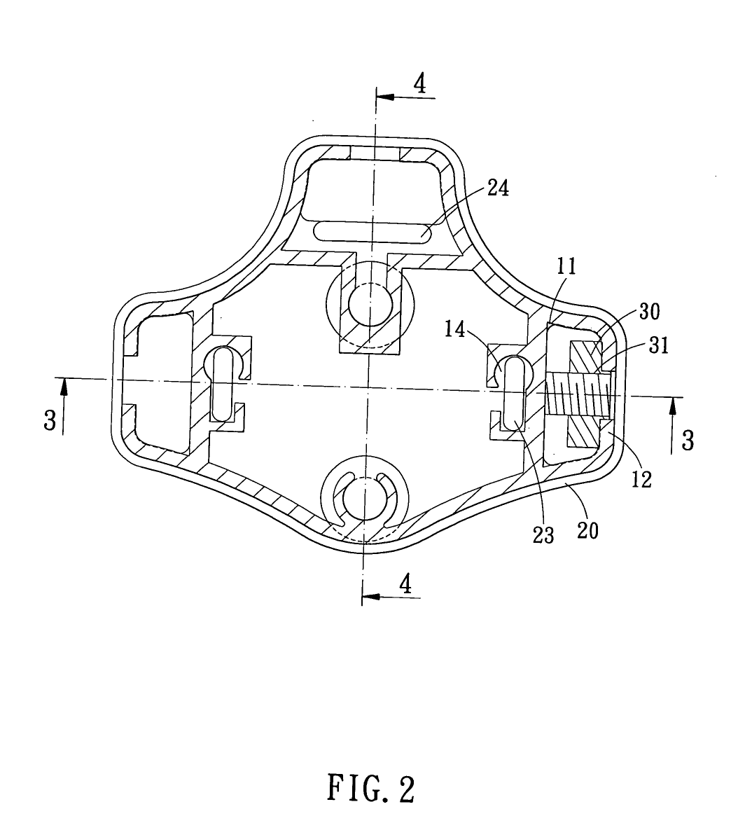

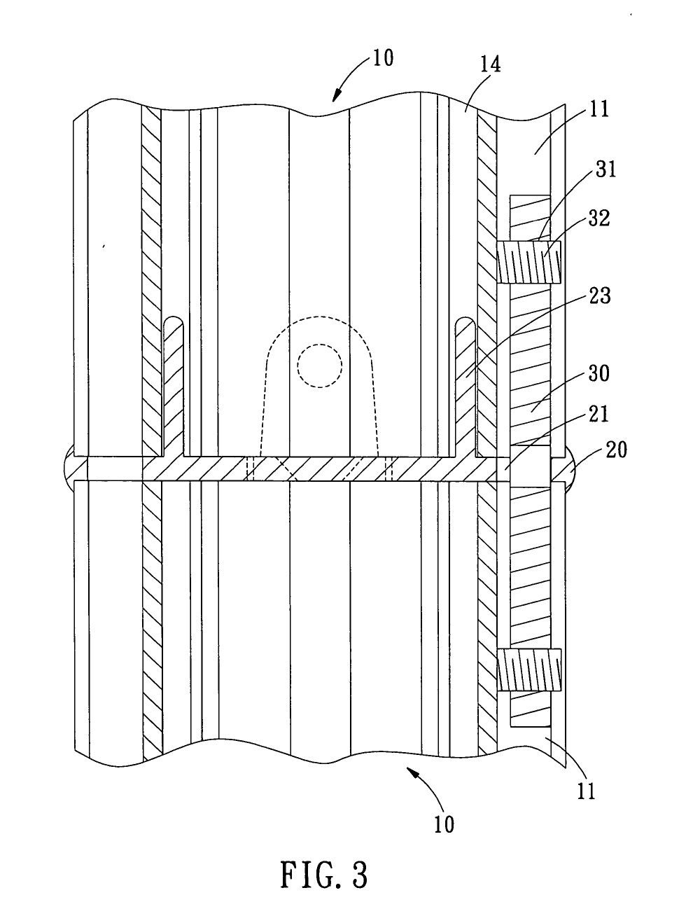

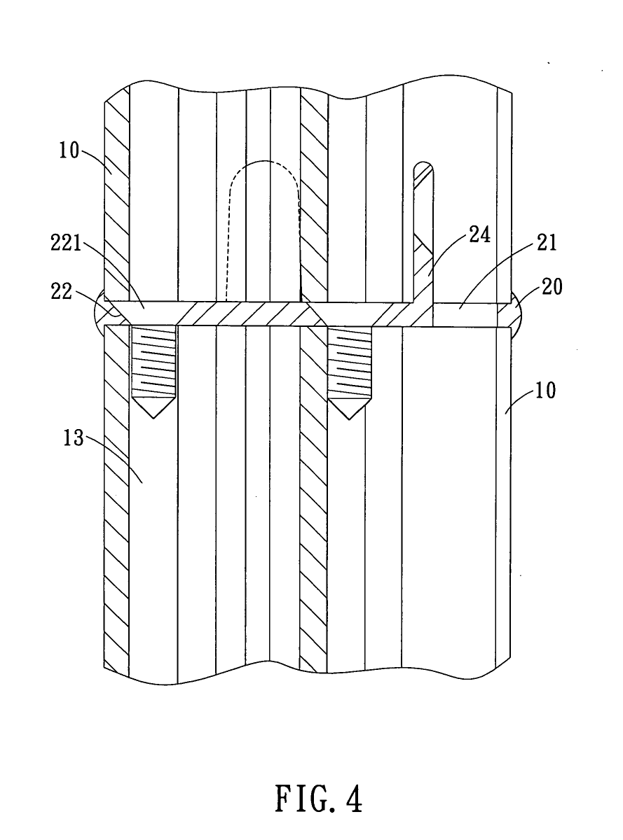

For a better understanding of the present invention, its function and operation, references should be made back to FIGS. 1-4, to connect the connecting member 20 to a first beam 10, the conical fixing holes 22 of the connecting member 20 should be aligned to the connecting grooves 13 of the first beam 10 initially, and then the screws 221 are screwed through the conical fixing holes 22 of the connecting member 20 into the connecting grooves 13 of the first beam 10, so that the through hole 21 of the connecting member 20 will accordingly be connected to the axial guide rails 11 at both sides of the first beam 10.

And then, a second beam 10 is connected to the connecting member 20 by inserting the connecting portion 23 of the connecting member 20 into the locking grooves 14 of the second beam 10, and the projection 24 is inserted in the axial guide rail 11 adjacent to the connecting groove 13 of the second beam 10.

Through this way, the two beams 10 are connected together by the connecting member 20.

The structure of the beam 10 is designed to allow the slide member 30 to be adjustably disposed in the axial guide rail 11 of the beam 10, by screwing socket head screws 32 in the threaded holes 31 of the slide member 30, the edges of the slide member 30 will be caused to press against the flanges 12 of the beam 10, this method enables the slide member 30 to be positioned firmly and adjustably on the beam 10.

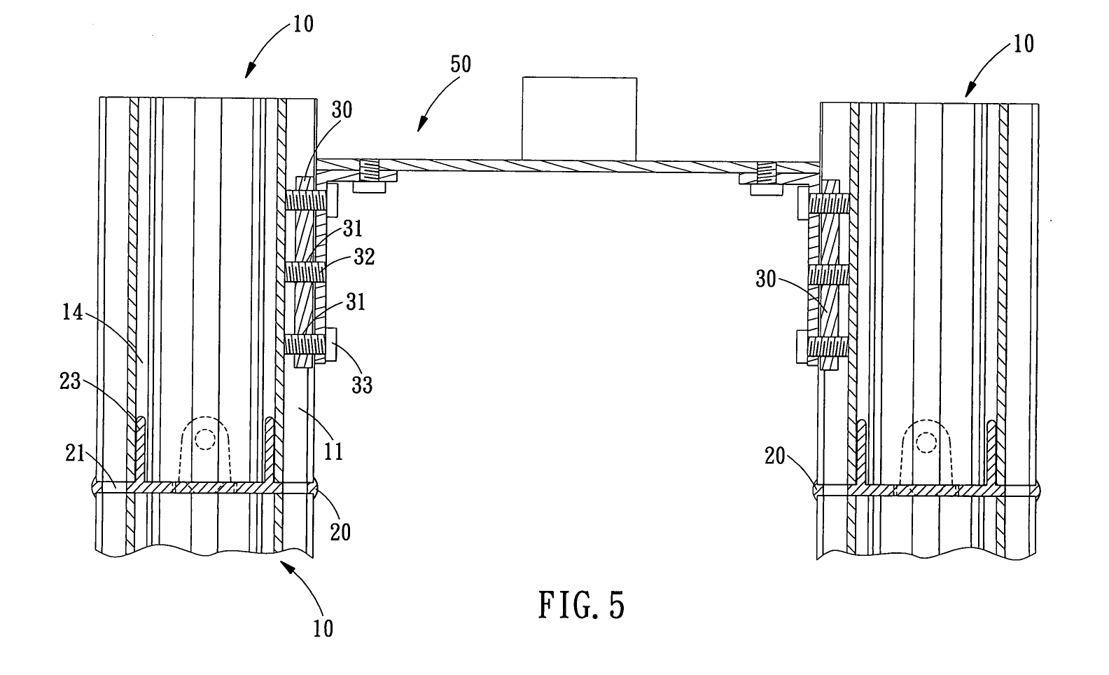

After finishing the connection of two beams 10, a shelf 50 then can be fixed to one of the beams 10 by screwing socket head screws 32 and general screws 33 into the threaded holes 31 of the slide member 30, as shown in FIG. 5, so as to form a storage rack.

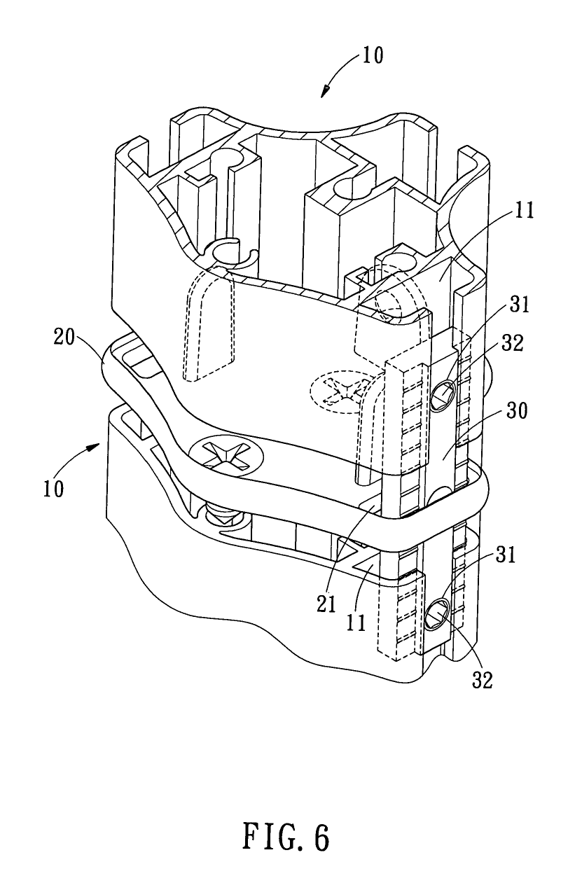

Referring to FIG. 6, the position of slide member 30 in the axial guide rail 11 of the beam 10 can be adjusted by adjusting the socket head screws 32. Furthermore, when adjusting the slide member 30, the slide member 30 can move via the through hole 21 into the axial guide rail 11 of another beam 10.

While we have shown and described various embodiments in accordance with the present invention, it should be clear to those skilled in the art that further embodiments may be made without departing from the scope of the present invention.

What is claimed is:

1. A beam-to-beam connection structure for a storage rack comprising:
at least two beams, each of which being provided with axial guide rails, at either side surface of the respective axial guide rails is defined a flange, in the respective beams being defined connecting grooves and locking grooves;
a connecting member provided with through holes and fixing holes correspondingly to the axial guide rails and the connecting grooves of the beams, respectively, screws being screwed through the fixing holes into the connecting grooves of the beam, the connecting member being formed with connecting portions employed to insert in the locking grooves of the beams.

2. The beam-to-beam connection structure for a storage rack as claimed in claim 1, wherein a projection is formed on the connecting member and is used to insert in the axial guide rails of the beams.

3. The beam-to-beam connection structure for a storage rack as claimed in claim 1, wherein a slide member is disposed in the axial guide rails of the respective beams, the slide member is connected with a shelf so as to form a storage rack, the slide can slide through the through holes of the connecting member after being adjusted.

4. The beam-to-beam connection structure for a storage rack as claimed in claim 2, wherein a slide member is disposed in the axial guide rails of the respective beams, the slide member is connected with a shelf so as to form a storage rack, the slide can slide through the through holes of the connecting member after being adjusted.

5. The beam-to-beam connection structure for a storage rack as claimed in claim 3, wherein the slide member provided with threaded holes, by screwing socket head screws in the threaded holes, an end of the socket head screws will press against a surface of the axial guide rails of the beams, thus enabling the slide member to be positioned in the axial guide rails of the beams.
